(19) United States
(12) Patent Application Publication
(10) Pub. No.: US 2023/0209146 A1
(43) Pub. Date: Jun. 29, 2023

(54) SIGNAL PROCESSING DEVICE WITH SCENE MODE SELECTION, AND RELATED DONGLE AND ADAPTOR CABLE

(71) Applicant: Realtek Semiconductor Corp., HsinChu (TW)

(72) Inventors: Yueh-Hsing Huang, HsinChu (TW); Wen-Tsai Liao, HsinChu (TW); Chia-Wei Yu, HsinChu (TW)

(73) Assignee: Realtek Semiconductor Corp., HsinChu (TW)

(21) Appl. No.: 17/731,249

(22) Filed: Apr. 27, 2022

(30) Foreign Application Priority Data
Dec. 24, 2021 (TW) 110148576

(51) Int. Cl. H04N 21/485; H04N 21/431; H04N 21/4363; H04N 21/435

(52) U.S. Cl. CPC H04N 21/4854; H04N 21/4316; H04N 21/4356; H04N 21/43635

(57) ABSTRACT

The present invention provides a signal processing device including a receiver, a signal processor and a transmitter. The receiver is configured to receive a first video signal. The signal processor is coupled to the receiver and configured to support a plurality of scene modes, select a current scene mode form the plurality of scene modes according to a user input, and operate in the current scene mode to process the first video signal to generate a second video signal. The transmitter is configured to output the second video signal.

### BACKGROUND OF THE INVENTION

### 1. Field of the Invention

The invention relates to signal processing, and more particularly, to a signal processing device that processes the signal through on screen display (OSD) processing.

### 2. Description of the Prior Art

Nowadays, most of video and audio signal processing products only provide a single processing effect but not a scene mode selection mechanism. Therefore, when a user desires to have best effects in different application scenarios, the user can only choose different products to obtain different effects. For example, when a user wants to watch a movie, he/she must choose a product that enhances the video and audio effects of the movie; when a user wants to play a video game, he/she must choose a product that enhances the game screen/sound effect. Furthermore, the actual processing effects of different audio and video signal processing products can be known by the user just after the user needs to change the product. Therefore, the current video and audio signal processing products do not have any mechanism for allowing users to quickly switch between different signal processing effects for selecting the most suitable signal processing effect applied to the current scene. Thus, a novel method and associated architecture are needed for quickly switching scene modes and displaying signal processing effects on the screen with no or fewer side effects.

### SUMMARY OF THE INVENTION

It is an objective of the present invention to provide a signal processing device that can be configured to quickly switch between different scene modes and can process the signal through on screen display (OSD) processing, such that the user can select the most suitable scene mode according to the processed signal displayed on the display, in order to solve the above-mentioned problems.

At least one embodiment of the present invention provides a signal processing device comprising a receiver, a signal processor and a transmitter. The receiver is configured to receive a first video signal. The signal processor is coupled to the receiver, and configured to support a plurality of scene modes, select a current scene mode from the plurality of scene modes according to a user input, and operate in the current scene mode to process the first video signal to generate a second video signal. The transmitter is configured to output the second video signal.

At least one embodiment of the present invention provides a dongle device comprising a signal processing device, a first connector and a second connector. The signal processing device comprises a receiver, a signal processor and a transmitter. The receiver is configured to receive a first video signal. The signal processor is coupled to the receiver, and configured to support a plurality of scene modes, select a current scene mode from the plurality of scene modes according to a user input, and operate in the current scene mode to process the first video signal to generate a second video signal. The transmitter is configured to output the second video signal. The first connector is coupled to the receiver. The second connector is coupled to the transmitter. The first video signal is received from a player device through the first connector and the second video signal is provided to a display device through the second connector.

At least one embodiment of the present invention provides an adaptor cable comprising a signal processing device, a cable and a connector. The signal processing device comprises a receiver, a signal processor and a transmitter. The receiver is configured to receive a first video signal. The signal processor is coupled to the receiver, and configured to support a plurality of scene modes, select a current scene mode from the plurality of scene modes according to a user input, and operate in the current scene mode to process the first video signal to generate a second video signal. The transmitter is configured to output the second video signal. The cable is coupled to one of the receiver and the transmitter. The connector is coupled to another of the receiver and the transmitter. When the cable is coupled to the receiver, the first video signal is received from a playback device through the cable, and the second video signal is provided to a display device through the connector. When the cable is coupled to the transmitter, the first video signal is received from the playback device through the connector, and the second video signal is provided to the display device through the cable.

One of the advantages of the present invention is that the processed signal in the current scene mode can be displayed via on screen display (OSD). The signal processing device of the present invention can provide a directly visible selection mechanism to a user. The user may select the operating scene mode according to the current application scene, and may further select the intensity of processing the video signal in the scene mode. In comparison with the related art, the present invention can select the scene mode under the condition of direct visualization. In addition, the present invention can realize a signal processing device capable of rapidly switching between different scene modes with no or fewer side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a signal processing device according to an embodiment of the invention.

FIG. 2 is a block diagram of the signal processing device applied to a playback system according to an embodiment of the present invention.

FIG. 3 is a diagram illustrating a plurality of scene modes of the signal processing device according to an embodiment of the present invention.

FIG. 4 is a block diagram illustrating a dongle device having the signal processing device applied to a playback system according to an embodiment of the present invention.

FIG. 5 is a diagram showing the dongle device product in FIG. 4.

FIG. 6 is a block diagram illustrating an adaptor cable having the signal processing device applied to a playback system according to an embodiment of the present invention.

FIG. 7 is a diagram showing the adaptor cable product in FIG. 6.

### DETAILED DESCRIPTION

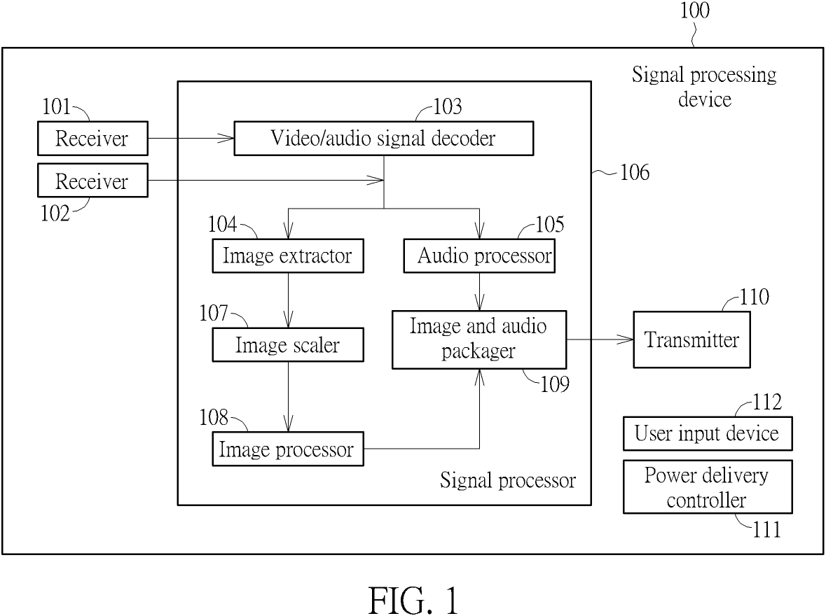

FIG. 1 is a block diagram of a signal processing device 100 according to an embodiment of the invention. The signal processing device 100 may comprise a plurality of functional blocks, and each functional block may be configured to perform corresponding signal processing. The aforementioned functional blocks may be implemented by corresponding hardware circuits and may be integrated into a signal processor 106. The aforementioned functional blocks may also be implemented by a microprocessor executing corresponding software or firmware, and the microprocessor becomes the signal processor 106 comprised in the signal processing device 100 when executing the corresponding software/firmware. In addition, the implementation of the aforementioned functional blocks may also be a combination of the aforementioned two implementations. The signal processing device 100 may comprise one or more receivers, e.g., the receiver 101 and the receiver 102. When the signal processing device 100 comprises a plurality of receivers, the receivers may be configured to receive and transmit signals in compliance with different transmission interface standards, respectively. For example, in one embodiment of the invention, the receiver 101 may be a Universal Serial Bus (USB) receiver, and the receiver 102 may be a High Definition Multimedia Interface (HDMI) receiver. When the playback device is a product with a USB interface, the receiver 101 may receive the video signal from the playback device through the USB interface, where the playback device transmits the video signal according to the USB standard. Similarly, when the playback device is a product with an HDMI interface, the receiver 102 may receive the video signal from the playback device through the HDMI interface, where the playback device transmits the video signal according to the HDMI standard. However, it is understood that the interfaces of the receivers are not limited thereto. In some embodiments, the receivers can be provided with DisplayPort (DP), USB Type C, or other interfaces.

The signal processor 106 of the signal processing device 100 may further comprise a video/audio signal decoder 103, an image extractor 104, and an audio processor 105. The video/audio signal decoder 103 may be configured to decode the received video signal or audio signal into a predetermined format based on requirements. The image extractor 104 may extract image data from the video signal. The audio processor 105 may extract audio data from the video signal, and process the audio signal according to the audio format. For example, the audio processor 105 performs audio signal processing on the audio data, where the audio signal processing may be, for example, noise elimination, signal purification, signal amplification, etc., but the present invention is not limited thereto.

In addition, the signal processor 106 of the signal processing device 100 may further comprise an image scaler 107, an image processor 108 and an image and audio packager 109. The image scaler 107 is configured to scale the image. For example, the image scaler 107 may adjust the size and/or resolution of the image based on the current image resolution. For example, an image interpolation method is used to add extra pixels, so as to improve the resolution of the output image. The image processor 108 is configured to perform corresponding processing according to the current image format and image resolution, to further improve image quality. By way of example, but not limitation, the corresponding processing may be edge sharpening, denoising, contrast enhancement, smoothing processing, etc. The image and audio packager 109 is configured to package the processed audio data and image data into video signals. The signal processing device 100 may further comprise a transmitter 110, a power delivery controller 111 and a user input device 112. The transmitter 110 is configured to output the video signals. The power delivery controller 111 is configured to acquire power from the peripheral device (e.g., the playback device or the display device) coupled thereto, and provide the power to the internal components of the signal processing device 100 (note that the coupling relationship between them is not shown in FIG. 1) for the internal components to operate. The user input device 112 is configured for receiving a user input, where the user input can control the signal processor 106 to switch to a current scene mode and perform various related settings in the current scene mode. For example, the user input device 112 is a button or a remote control receiver.

The receivers 101 and 102 of the signal processing device 100 of the present invention are configured to receive a first video signal from an external circuit, and the signal processor 106 of the signal processing device 100 supports a plurality of scene modes. In other words, the signal processor 106 can be configured to select the current scene mode from a plurality of scene modes according to the user input, and operate in the current scene mode to process the first video signal to generate a second video signal. The transmitter 110 is configured to output the second video signal. Different scene modes can apply different processing to the first video signal for presenting different video processing effects, and the signal processor 106 superimposes a video processing effect on the first video signal through on screen display (OSD) processing to generate the second video signal. Therefore, the present invention can reduce the processing time of the first video signal. For example, when a user makes the signal processing device 100 receive a user input through the user input device 112 and the user input selects a game scene mode as the current scene mode, the signal processor 106 adjusts the sharpness and contrast of the first video signal, and improves the resolution, but the present invention is not limited thereto. The video processing result obtained after the game scene mode is selected can be displayed on the display device in real time, so that the user can select the most suitable scene mode through a directly visible selection mechanism.

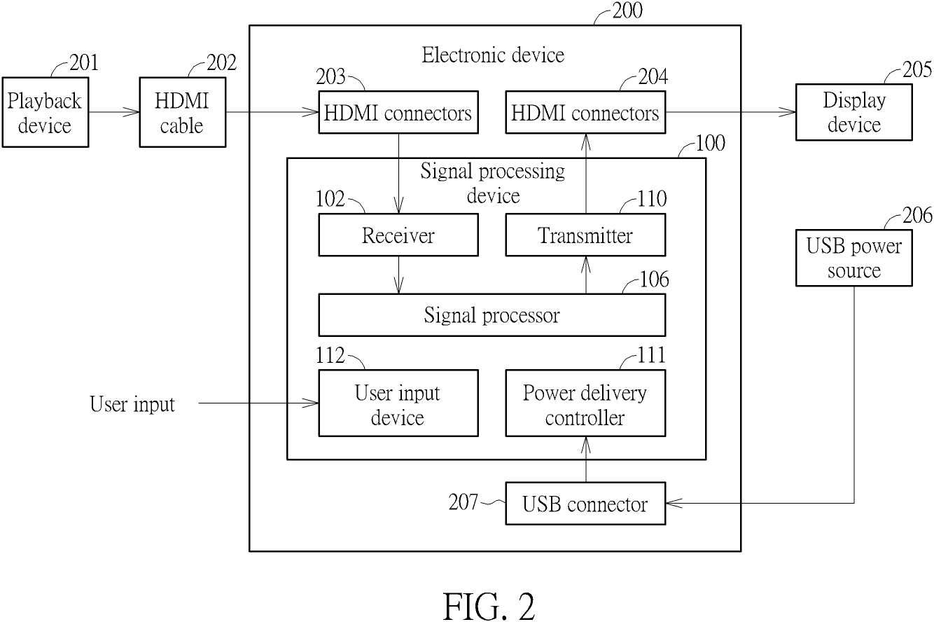

Please refer to FIG. 2. FIG. 2 is a block diagram of the signal processing device 100 applied to a playback system according to an embodiment of the present invention. As shown in FIG. 2, it is assumed that the playback system comprises a playback device 201 with an HDMI interface and a display device 205 (such as a television) with an HDMI interface, and the signal processing device 100 is powered from a USB power source 206 of the display device 205 (such as a USB port of the television). For example, one terminal of the electronic device 200 is coupled to the display device 205. By way of illustration, the electronic device 200 may be connected to one port of the display device 205 through a connector, or may be plugged into one port of the display device 205 through a plug. The other terminal of the electronic device 200 is coupled to an HDMI cable 202, and is coupled to the playback device 201 through the HDMI cable 202. That is, in this example, the electronic device 200 including the signal processing device 100 is a component arranged on a signal transmission path between the playback device 201 and the display device 205, and the signal transmission path may further comprise a cable coupled to the playback device 201. It is noted that FIG. 2 only shows one of various implementations of the electronic device 200 equipped with the signal processing device 100 of the present invention. Therefore, the present invention is not limited to the playback system shown in FIG. 2. For example, the electronic device 200 can also be designed to be a device which can be plugged into or coupled to the playback device 201, that is, one terminal of the electronic device 200 is coupled to the playback device 201 and the other terminal of the electronic device 200 is coupled to the display device 205 through a cable or a transmission line. The electronic device 200 comprises the signal processing device 100, HDMI connectors 203 and 204 and a USB connector 207. The signal processing device 100 may comprise the receiver 102, the transmitter 110, the signal processor 106, the power delivery controller 111 and the user input device 112. In this example, the receiver 102 may be an HDMI receiver, and the transmitter 110 may be an HDMI transmitter. The receiver 102 can be coupled to the HDMI connector 203, and the signal processing device 100 receives the video signal output by the playback device 201 through the HDMI connector 203 and the HDMI cable 202 that is external to the electronic device 200. The transmitter 110 can be coupled to the HDMI connector 204, and the video signal processed by the signal processing device 100 can be provided to the display device 205 through the HDMI connector 204.

In this example, the input connector and the output connector are the connectors of the same interface, that is, the connectors of the HDMI interface. However, the present invention is not limited thereto, and the input connector and the output connector can also be connectors of different video interfaces. Furthermore, in this example, the power input is a USB power source 206, where the interface connecting the playback device 201 and the display device 205 has a USB interface, and the USB connector for receiving/transmitting signals and the USB connector 207 for receiving power can be merged into a single USB connector.

According to the above arrangement, the electronic device 200 equipped with the signal processing device 100 of the present invention can receive a first video signal from the playback device 201 through the HDMI connector 203, and the signal processor 106 of the signal processing device 100 can be configured to select a current scene mode from the plurality of scene modes according to a user input, and operate the current scene mode to process the first video signal to generate a second video signal. The transmitter 110 is configured to output the second video signal, and the HDMI connector 204 is configured to transmit the second video signal to the display device 205. Different scene modes can perform different processing operations on the first video signal to present different video processing effects on the display device 205, and the signal processor 106 superimposes a video processing effect on the first video signal through OSD processing to generate a second video signal, so the processing time of the first video signal can be reduced, and the display device 205 can quickly display the second video signal. For example, when a user operates the user input device 112, the signal processing device 100 receives a user input from the user input device 112. If the user input selects a portrait scene mode as the current scene mode, the signal processor 106 performs saturation adjustment, flesh tone adjustment and/or resolution improvement on the first video signal. The video processing result obtained after the portrait scene mode is selected can be displayed on the display device 205 in real time. Therefore, the user can select the most suitable scene mode through a directly visible selection mechanism.

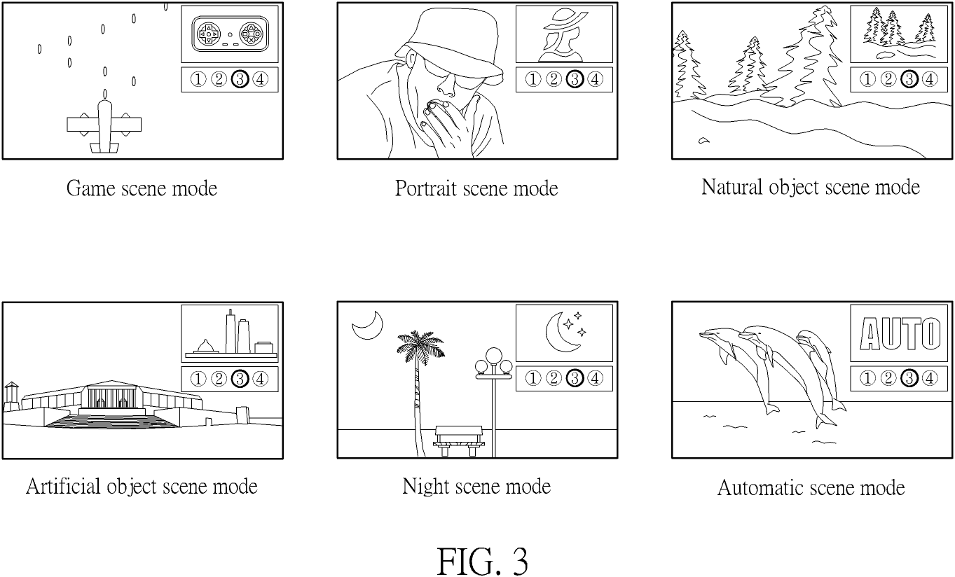

Please refer to FIG. 3. FIG. 3 is a diagram illustrating a plurality of scene modes of the signal processing device 100 according to an embodiment of the present invention. The scene modes shown in FIG. 3 are only used as illustrative examples, so the multiple scene modes of the signal processing device 100 of the present invention are not limited thereto, and the schematic diagrams of the scene modes are not limited to the shapes shown in FIG. 3. For example, the signal processing device 100 of the present invention may be operated to generate a video processing result according to a game scene mode, a portrait scene mode, a natural object scene mode, an artificial object scene mode, a night scene mode and an automatic scene mode. The image/audio items which are adjusted by individual scene modes can be different. For example, when the current scene mode is set by the game scene mode, the signal processor 106 performs sharpness adjustment, contrast adjustment and/or resolution improvement of the first video signal; when the current scene mode is set by the portrait scene mode, the signal processor 106 performs saturation adjustment, flesh tone adjustment and/or resolution improvement of the first video signal; when the current scene mode is set by the natural object scene mode, the signal processor 106 performs saturation adjustment, edge enhancement adjustment and/or resolution improvement on the first video signal; when the current scene mode is set by the artificial object scene mode, the signal processor 106 performs edge enhancement adjustment, edge smooth adjustment and/or resolution improvement on the first video signal; when the current scene mode is set by the night scene mode, the signal processor 106 performs dynamic range adjustment, edge enhancement adjustment and/or resolution improvement of the first video signal. Please note that the processing items made by the above scene modes are only used for illustration and example, and the present invention is not limited thereto.

When the current scene mode is set by the automatic scene mode, the signal processor 106 can divide the first video signal into a plurality of sections according to the contents. After detecting these sections respectively, the signal processor 106 can further set each section to one of the plurality of scene modes according to the content of each section. In other words, when the current scene mode is the automatic scene mode and an image of the first video signal comprises portraits, artificial objects, and natural objects, etc., the signal processor 106 detects the sections of the first video signal respectively, generates video processing result(s) for the section(s) with portraits according to the portrait scene mode, generates video processing result(s) for the section(s) with artificial objects according to the artificial object scene mode, and generates video processing result(s) for the section(s) with natural objects according to the natural object scene mode.

In addition, each scene mode of the plurality of scene modes corresponds to an adjustable processing intensity, and the processing intensity is the degree to which the signal processor 106 processes the first video signal in the current scene mode. As shown in FIG. 3, the processing intensity of a scene mode is represented by numbers 1 to 4 below a schematic diagram of the scene mode (i.e. the block at the upper right of the frame). For example, a greater number indicates that the signal processor 106 processes the first video signal in the current scene mode with a stronger degree. For example, assuming that the signal processor 106 performs sharpness adjustment in the current scene mode, sharpness of objects in the frame is higher when the processing intensity becomes stronger. By way of illustration, when the processing intensity is 1, the processing degree is 20%; when the processing intensity is 2, the processing degree is 50%; when the processing intensity is 3, the processing degree is 70%; when the treatment intensity is 4, the processing degree is 90%. The processing intensity is only used for illustration and example, and the present invention is not limited thereto.

In addition, when the user input device 112 is a physical button, the signal processing device 100 can be controlled by long depressing (e.g., depressing for more than 2 seconds) or short depressing (e.g., depressing for less than 0.5 seconds) on the button. For example, long depressing of the button may be set to instruct the signal processing device 100 to enter the scene mode selection and display OSD; short depressing of the button may be set to instruct the signal processing device 100 to switch between different scene modes in sequence for current scene mode selection; depressing the button in a period between a period of long depressing of the button and a period of short depressing of the button may be set to instruct the signal processing device 100 to confirm the selection of the relevant processing items of the current scene mode, and one following short depressing of the button may instruct the signal processing device 100 to switch the confirmed scene mode; and two consecutive short depressing of the button may be set to instruct the signal processing device 100 to leave the scene mode selection. These button settings are only used for illustration and example, and the present invention is not limited thereto.

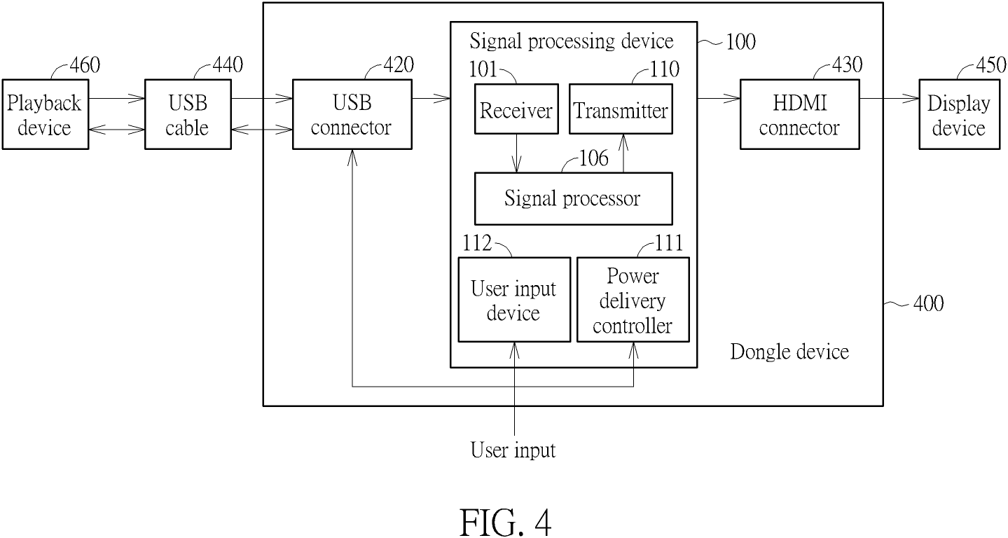

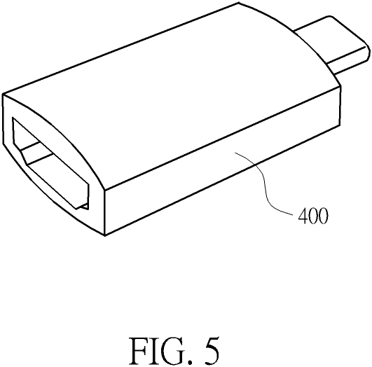

The electronic device 200 having the signal processing device 100 of the present invention may be an electronic device used in an audio/video (A/V) device, such as a dongle or an adaptor cable for transmitting A/V signal from a playback device to a display device. For example, please refer to FIG. 4 in conjunction with FIG. 5. FIG. 4 is a block diagram illustrating a dongle device 400 having the signal processing device 100 applied to a playback system according to an embodiment of the present invention. FIG. 5 is a diagram showing the dongle device product in FIG. 4. As shown in FIG. 4, the signal processing device 100 is implemented in the dongle device 400. One end (such as an HDMI connector 430) of the dongle device 400 is coupled to the display device 450. For example, the dongle device 400 may be connected to one port of the display device 450 through an HDMI connector, or may be plugged into one port of the display device 450 through an HDMI plug. Another end (such as a USB connector 420) of the dongle device 400 is coupled to a USB cable 440, and the dongle device 400 is coupled to the playback device 460 through the USB cable 440. In this implementation, the first video signal is transmitted to the signal processing device 100 through the USB connector 420, and the power is also transmitted to the power delivery controller 111 of the signal processing device 100 through the USB connector 420. After receiving the first video signal from the receiver 102, the signal processor 106 selects a current scene mode from the plurality of scene modes according to a user input from the user input device 112, and operates in the current scene mode to process the first video signal to generate a second video signal. The transmitter 110 is used for outputting the second video signal, and transmits the second video signal to the display device 450 through the HDMI connector 430 of the dongle device 400. As shown in FIG. 5, the dongle device 400 can be implemented according to this product structure. It should be noted that FIG. 4 and FIG. 5 show one of the various embodiments of the present invention. Therefore, the playback system with the dongle device 400 is not limited to the embodiment shown in FIGS. 4 and 5. For example, the dongle device 400 can be designed to be a device that is plugged into or coupled to the playback device, that is, one end of the dongle device 400 is coupled to the playback device 460, and the other end of the dongle device 400 is coupled to the display device 450 through a cable or a transmission line.

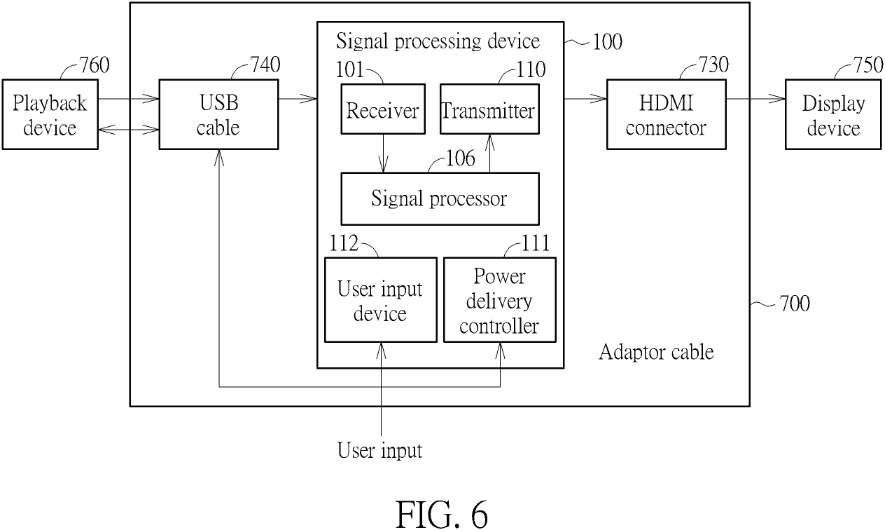

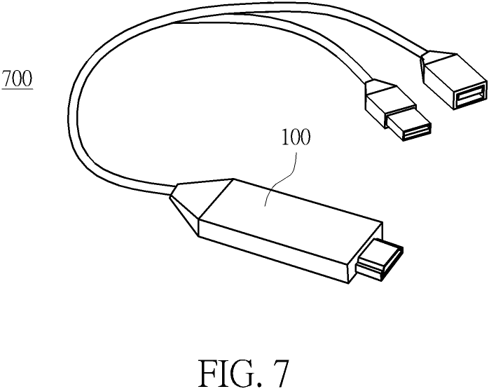

For another example, please refer to FIG. 6 in conjunction with FIG. 7. FIG. 6 is a block diagram illustrating an adaptor cable 700 having the signal processing device 100 applied to a playback system according to an embodiment of the present invention. FIG. 7 is a diagram showing the adaptor cable product in FIG. 6. As shown in FIG. 6, the signal processing device 100 is implemented in the adaptor cable 700. One end (such as an HDMI connector 730) of the adaptor cable 700 is coupled to the display device 750. For example, the adaptor cable 700 may be connected to one port of the display device 750 through a connector, or may be plugged into one port of the display device 750 through a plug. Another end of the adaptor cable 700 is coupled to the playback device 760. For example, the adaptor cable 700 may be connected to one port of the playback device 760 through a connector, or may be plugged into one port of the display device 750 through a plug. In this implementation, a signal transmission device including the signal processing device 100 is a signal transmission element arranged on a signal transmission path between the playback device and the display device. The first video signal is transmitted to the signal processing device 100 through the USB cable 740, and the power is also transmitted to the power delivery controller 111 of the signal processing device 100 through the USB connector 740. After receiving the first video signal from the playback device 760 from the receiver 102, the signal processor 106 selects a current scene mode from the plurality of scene modes according to a user input from the user input device 112, and operates in the current scene mode to process the first video signal to generate a second video signal. The transmitter 110 is used to output the second video signal, and transmit the second video signal to the display device 750 through the HDMI connector 730 of the adaptor cable 700. As shown in FIG. 7, the adaptor cable 700 can be implemented according to this product structure, and the signal processing device 100 can be arranged in a larger connector. It should be noted that FIG. 6 and FIG. 7 show one of the various embodiments of the present invention. Therefore, the playback system with the adaptor cable 700 is not limited to the embodiment shown in FIGS. 6 and 7.

One of the advantages of the present invention is that the processed signal in the current scene mode can be displayed via on screen display (OSD). The signal processing device of the present invention can provide a directly visible selection mechanism to a user. The user may select the operating scene mode according to the current application scene, and may further select the intensity of processing the video signal in the scene mode. In comparison with the related art, the present invention can select the scene mode under the condition of direct visualization. In addition, the present invention can realize a signal processing device capable of rapidly switching between different scene modes with no or fewer side effects.

Those skilled in the art will readily observe that numerous modifications and alterations of the device and method may be made while retaining the teachings of the invention. Accordingly, the above disclosure should be construed as limited only by the metes and bounds of the appended claims.

1. A signal processing device, comprising:
a receiver, configured to receive a first video signal;
a signal processor, coupled to the receiver, and configured to support a plurality of scene modes, select a current scene mode from the plurality of scene modes according to a user input, and operate in the current scene mode to process the first video signal to generate a second video signal; and
a transmitter, configured to output the second video signal;
wherein the receiver is one of a Universal Serial Bus (USB) receiver, a High Definition Multimedia Interface (HDMI) receiver, a DisplayPort (DP) receiver, and a USB Type C receiver;
wherein the transmitter is one of a USB transmitter, an HDMI transmitter, a DP transmitter, and a USB Type C transmitter.

2. The signal processing device of claim 1, wherein the signal processor superimposes a video processing effect on the first video signal through on screen display (OSD) processing to generate the second video signal.

3. The signal processing device of claim 1, further comprising:
an input connector, coupled to the receiver, and configured to connect to an external signal source, receive the first video signal from the external signal source, and transmit the first video signal to the receiver; and
an output connector, coupled to the transmitter, and configured to connect to an external display device, and provide the second video signal output by the transmitter to the external display device.

4. The signal processing device of claim 3, wherein the input connector and the output connector are connectors of different video interfaces.

5. The signal processing device of claim 3, wherein the input connector and the output connector are connectors of identical video interfaces.

6. The signal processing device of claim 1, wherein the current scene mode is a game scene mode, and the signal processor operates in the game scene mode to perform at least one of sharpness adjustment, contrast adjustment and resolution improvement on the first video signal.

7. The signal processing device of claim 1, wherein the current scene mode is a portrait scene mode, and the signal processor operates in the portrait scene mode to perform at least one of saturation adjustment, flesh tone adjustment and resolution improvement on the first video signal.

8. The signal processing device of claim 1, wherein the current scene mode is a natural object scene mode, and the signal processor operates in the natural object scene mode to perform at least one of saturation adjustment, edge enhancement adjustment and resolution improvement on the first video signal.

9. The signal processing device of claim 1, wherein the current scene mode is an artificial object scene mode, and the signal processor operates in the artificial object scene mode to perform at least one of edge smoothing, edge enhancement and resolution improvement on the first video signal.

10. The signal processing device of claim 1, wherein the current scene mode is a night scene mode, and the signal processor operates in the night scene mode to perform at least one of dynamic range adjustment, edge enhancement and resolution improvement on the first video signal.

11. The signal processing device of claim 1, wherein the current scene mode is an automatic scene mode, and the signal processor operates in the automatic scene mode to divide the first video signal into a plurality of sections, detect the plurality of sections, and generate a video processing result of each section by setting said each section to one of the plurality of scene modes according to a content of said each section.

12. The signal processing device of claim 1, wherein each scene mode of the plurality of scene modes has an adjustable processing intensity.

13. The signal processing device of claim 1, further comprising:
a user input device, configured to receive the user input, wherein the user input controls the signal processor to switch to the current scene mode and to process related settings in the current scene mode.

14. The signal processing device of claim 13, wherein the user input device is a button or a remote control receiver.

15. A dongle device, comprising:
a signal processing device, comprising;
a receiver, configured to receive a first video signal;
a signal processor, coupled to the receiver, and configured to support a plurality of scene modes, select a current scene mode from the plurality of scene modes according to a user input, and operate in the current scene mode to process the first video signal to generate a second video signal; and
a transmitter, configured to output the second video signal; and
a first connector, coupled to the receiver; and
a second connector, coupled to the transmitter,
wherein the first video signal is received from a playback device through the first connector and the second video signal is provided to a display device through the second connector;
wherein the first connector and the second connector are selected from two of a Universal Serial Bus (USB) connector, a High Definition Multimedia Interface (HDMI) connector, a DisplayPort (DP) connector and a USB Type C connector.

16. (canceled)

17. An adaptor cable, comprising:
a signal processing device, comprising;
a receiver, configured to receive a first video signal;
a signal processor, coupled to the receiver, and configured to support a plurality of scene modes, select a current scene mode from the plurality of scene modes according to a user input, and operate in the current scene mode to process the first video signal to generate a second video signal; and
a transmitter, configured to output the second video signal;
a cable, coupled to one of the receiver and the transmitter; and
a connector, coupled to another of the receiver and the transmitter,
wherein when the cable is coupled to the receiver, the first video signal is received from a playback device through the cable, and the second video signal is provided to a display device through the connector; and when the cable is coupled to the transmitter, the first video signal is received from the playback device through the connector and the second video signal is provided to the display device through the cable;
wherein the cable is a High Definition Multimedia Interface (HDMI) cable or a Universal Serial Bus (USB) cable, a DisplayPort (DP) cable or a USB Type C cable, and the connector is an HDMI connector, a USB connector, a DP connector or a USB Type C connector.

18. (canceled)
